(19) United States
(12) Patent Application Publication
(10) Pub. No.: US 2024/0153672 A1
(43) Pub. Date: May 9, 2024

(54) WATER-STOP STRUCTURE OF WIRE AND MANUFACTURING METHOD THEREOF

(71) Applicant: Yazaki Corporation, Tokyo (JP)

(72) Inventors: Eiichi TOHYAMA, Shizuoka (JP); Michitake MASUDA, Shizuoka (JP); Hideyuki WADA, Shizuoka (JP)

(73) Assignee: Yazaki Corporation, Tokyo (JP)

(21) Appl. No.: 18/494,077

(22) Filed: Oct. 25, 2023

(30) Foreign Application Priority Data
Oct. 31, 2022 (JP) 2022-174190

(51) Int. Cl. H01B 7/285; H01B 3/30; H01B 7/08

(52) U.S. Cl. CPC H01B 7/285; H01B 3/305; H01B 7/0876; H01R 4/72

(57) ABSTRACT

A water-stop structure of a wire includes a wire and a sealing member. The wire includes a covering portion configured to cover a plurality of element wires being twisted, and an element wire exposing portion in which the plurality of element wires being twisted are partially exposed from the covering portion. The sealing member seals the element wire exposing portion of the wire under a state in which the plurality of element wires in the element wire exposing portion of the wire are untwisted.

### CROSS-REFERENCE TO RELATED APPLICATIONS

The present application is based on, and claims priority from the prior Japanese Patent Application No. 2022-174190, filed on Oct. 31, 2022, the entire contents of which are incorporated herein by reference.

### TECHNICAL FIELD

The present disclosure relates to a water-stop structure of a wire and a manufacturing method thereof.

### BACKGROUND

In a vehicle, a wire that is routed on an engine room side is easily exposed to water, for example. In particular, when a non-waterproof terminal is connected to one end of a wire, and an electronic device such as an electronic control unit (ECU) is connected to the other end of the wire, water may enter the inside of the wire from the one end of the wire to which the non-waterproof terminal is connected, due to capillarity. The wire is required to be subjected to water-stop treatment in order to prevent electric leakage, a short circuit, or the like in the electric device connected to the other end of the wire, which is caused by such entry of water from the one end of the wire. In JP 2009-152012 A, water-stop is performed by a method of removing a covering layer at an intermediate portion of a wire to expose element wires, covering an element wire exposing portion with a heat shrinkable tube including an inner layer formed of a heat-meltable water-stop agent, heating the heat shrinkable tube, and filling a gap between the element wires in the element wire exposing portion with the water-stop agent being melted.

### SUMMARY

However, when an element wire exposing portion of a wire is obtained simply by removing a covering portion, almost no gap is generated between element wires in the element wire exposing portion. Thus, in some cases, a water-stop agent having relatively high viscosity does not adequately permeate between the element wires, and the element wire exposing portion of the wire cannot adequately be sealed.

The present disclosure has been made in view of this problem in the related art. Further, an object of the present disclosure is to provide a water-stop structure of a wire and a manufacturing method thereof that can adequately seal an element wire exposing portion of a wire by forming a gap between element wires in the element wire exposing portion of the wire.

A water-stop structure of a wire according to an embodiment includes a wire including a covering portion configured to cover a plurality of element wires being twisted and an element wire exposing portion in which the plurality of element wires being twisted are partially exposed from the covering portion, and a sealing member configured to seal the element wire exposing portion of the wire under a state in which the plurality of element wires in the element wire exposing portion of the wire are untwisted.

A manufacturing method of a water-stop structure of a wire according to an embodiment includes forming, in a wire including a covering portion configured to cover a plurality of element wires being twisted, an element wire exposing portion in which the plurality of element wires being twisted are partially exposed from the covering portion, forming a gap between the plurality of element wires by rotating the element wire exposing portion of the wire in a direction opposite to a twisting direction of the plurality of element wires and untwisting the plurality of element wires in the element wire exposing portion of the wire, and sealing the element wire exposing portion of the wire with a sealing member.

According to the configuration described above, it is possible to provide a water-stop structure of a wire and a manufacturing method thereof that can adequately seal an element wire exposing portion of a wire by forming a gap between element wires in the element wire exposing portion of the wire.

### BRIEF DESCRIPTION OF THE DRAWINGS

FIG. 1 is a perspective view schematically illustrating an example of a water-stop structure of a wire according to a first embodiment.

FIG. 2 is a view of the water-stop structure of the wire according to the first embodiment as viewed in the longitudinal direction of the wire.

FIG. 3 is an exploded view schematically illustrating an example of the water-stop structure of the wire according to the first embodiment.

FIG. 4 is an explanatory view illustrating an example of a step in a manufacturing method of the water-stop structure of the wire.

FIG. 5 is an explanatory view illustrating an example of a step in the manufacturing method of the water-stop structure of the wire.

FIG. 6 is an explanatory view illustrating an example of a step in the manufacturing method of the water-stop structure of the wire.

FIG. 7 is an explanatory view illustrating an example of a step in the manufacturing method of the water-stop structure of the wire.

FIG. 8 is an explanatory view illustrating an example of a step in the manufacturing method of the water-stop structure of the wire.

FIG. 9 is a perspective view schematically illustrating an example of a water-stop structure of a wire according to a second embodiment.

FIG. 10 is an explanatory view illustrating an example of a step in the manufacturing method of the water-stop structure of the wire.

### DETAILED DESCRIPTION

Various embodiments will be described hereinafter with reference to the accompanying drawings.

With reference to the drawings, a water-stop structure of a wire and a manufacturing method thereof according to the present embodiment is described below in detail. Note that dimensional ratios in the drawings are exaggerated for convenience of description, and may be different from actual ratios.

### First Embodiment

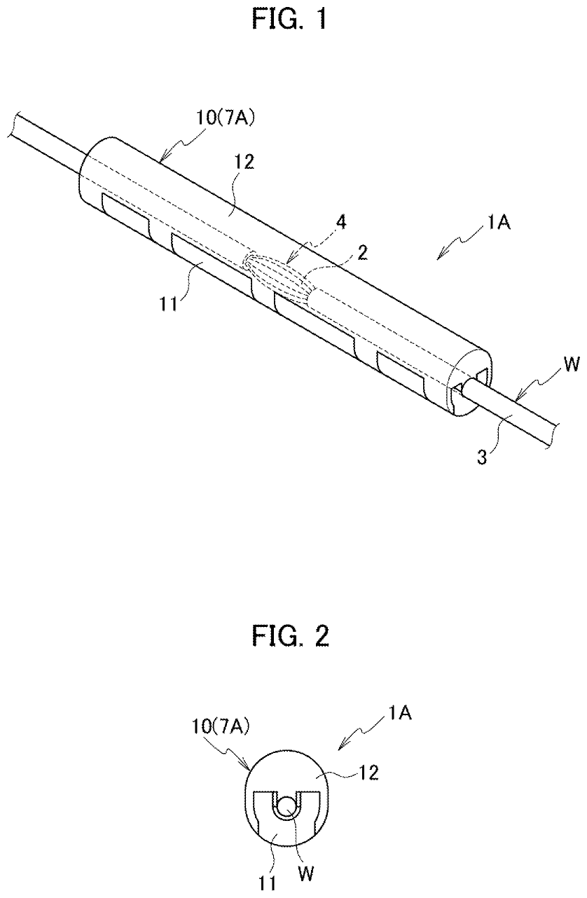

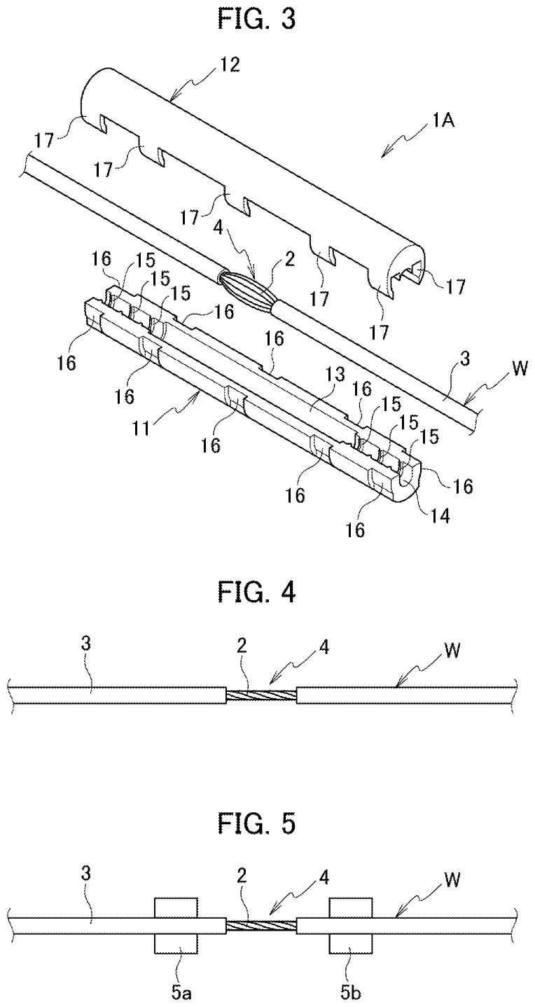

FIG. 1 is a perspective view illustrating a water-stop structure 1A of a wire W according to a first embodiment, FIG. 2 is a view of the water-stop structure 1A of the wire W according to the first embodiment as viewed in the longitudinal direction of the wire W, and FIG. 3 is an exploded view schematically illustrating an example the water-stop structure 1A of the wire W according to the first embodiment.

The water-stop structure 1A according to the first embodiment includes the wire W and a molded member 10 being a sealing member 7A.

For example, the wire W includes one end that is connected to a non-waterproof terminal (omitted in illustration) and the other end that is connected to an electric device (omitted in illustration) such as an electric control unit (ECU). The wire W is obtained by twisting a plurality of element wires 2 to form a conductor and covering the conductor with a covering portion 3 formed of an insulating body. In a middle portion of the wire W in the longitudinal direction, an element wire exposing portion 4 in which the element wires 2 are exposed is formed by removing a part of the covering portion 3. In other words, the wire W is configured to include the covering portion 3 that covers the plurality of element wires 2 being twisted and the element wire exposing portion 4 in which the plurality of element wires 2 being twisted are partially exposed from the covering portion 3

The sealing member 7A seals the element wire exposing portion 4 of the wire W under a state in which the plurality of element wires 2 in the element wire exposing portion 4 of the wire W are untwisted.

In the water-stop structure 1A of the wire W according to the first embodiment, the sealing member 7A is the molded member 10 formed of a thermoplastic resin material.

The molded member 10 is configured to include a primary molded component 11 on the lower side in FIG. 1 and a secondary molded component 12 on the upper side in FIG. 1. A length L1 of the molded member 10 (see FIG. 8) is approximately 50 mm, for example. The molded member 10 is formed by a thermoplastic resin material such as a polyamide-based resin, a polyester-based resin, a polyolefin-based resin, polypropylene, and a thermoplastic polymer (hot-melt).

In the primary molded component 11, a resin material filling space portion 13 in which the element wire exposing portion 4 of the wire W is arranged and wire pressing portions that press and retain the wire W at parts of the covering portion 3 are formed. Specifically, a groove portion 14 is provided along the axial line direction in the primary molded component 11, and the width of the groove portion 14 at the center portion of the primary molded component 11 in the axial line direction is increased more than the widths thereof at other positions to form the resin material filling space portion 13. Meanwhile, a plurality of pressing ribs 15 forming the wire pressing portions are formed in the groove portion 14 at both end portions of the primary molded component 11 in the axial line direction. Further, a plurality of engagement recess portions 16 are formed in the primary molded component 11, and engagement projection portions 17 formed on the secondary molded component 12 are engaged with the engagement recess portions 16, respectively.

Although details are described later, a thermoplastic resin material that fills a die at the time of molding the secondary molded component 12 enters the resin material filling space portion 13 of the primary molded component 11, and a gap between the plurality of element wires 2 in the element wire exposing portion 4 is filled with the thermoplastic resin material. After that, the secondary molded component 12 including a thermoplastic resin layer (omitted in illustration) filling the gap between the plurality of element wires 2 is formed by cooling and solidifying the thermoplastic resin material filling the die.

A manufacturing method of the water-stop structure 1A of the wire W according to the first embodiment is described below.

Each of FIG. 4 to FIG. 8 is an explanatory view illustrating an example of a step in the manufacturing method of the water-stop structure 1A of the wire W.

[1] Forming Element Wire Exposing Portion 4

In the middle portion of the wire W in the longitudinal direction, the element wire exposing portion 4 in which the element wires 2 are exposed by removing a part of the covering portion 3 is formed (see FIG. 4).

[2] Retaining Covering Portion 3 Near Element Wire Exposing Portion 4

The covering portion 3 near the element wire exposing portion 4 is retained by a pair of chucks 5a and 5b that sandwich the element wire exposing portion 4 therebetween (see FIG. 5).

[3] Applying Rotation to Element Wire Exposing Portion 4 in Direction D Opposite to Twisting Direction of Element Wires 2

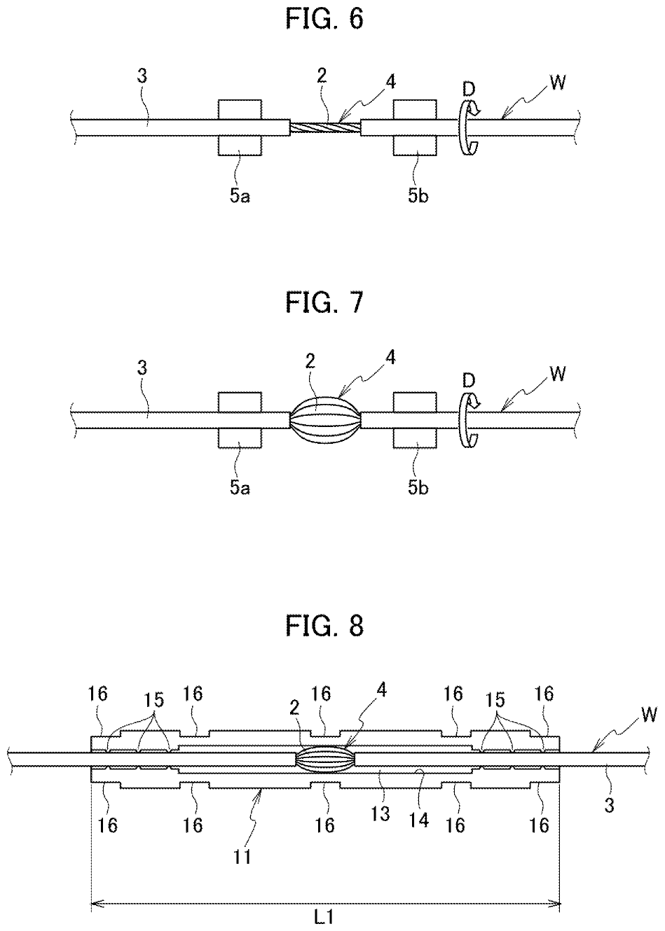

While fixing the position of the one chuck 5a of the pair of chucks 5a and 5b, the other chuck 5b is rotated by a predetermined angle in a direction D opposite to the twisting direction of the element wires 2 (see FIG. 6). The predetermined angle is approximately from 90 degrees to 180 degrees, for example.

[4] Forming Gap Between Element Wires 2 in Element Wire Exposing Portion 4

The element wires 2 in the element wire exposing portion 4 are untwisted by applying rotation to the element wire exposing portion 4 in the direction D opposite to the twisting direction of the element wires 2 (see FIG. 7). When the element wires 2 in the element wire exposing portion 4 are untwisted, the element wire exposing portion 4 expands in the radial direction of the wire W, and a space (gap) is generated between the element wires 2 in the element wire exposing portion 4.

[5] Water-Stop Treatment with Molded Member 10

The wire W in which the element wires 2 in the element wire exposing portion 4 are untwisted is arranged on the primary molded component 11 (see FIG. 8), the primary molded component 11 is set in a die, the die is filled with the thermoplastic resin material, and then the secondary molded component 12 is obtained through molding. In other words, permeation of an adhesive into the element wires 2 in the element wire exposing portion 4 is not performed in advance, and the secondary molded component 12 is obtained through molding by a molding method. In this manner, water-stop treatment for the element wire exposing portion 4 of the wire W is completed.

An adhesive agent with high fluidity is not required to permeate into the element wire exposing portion 4 in advance because the thermoplastic resin material enters the gap between the element wires 2 in the element wire exposing portion 4, and water-stop treatment for the element wire exposing portion 4 of the wire W can be performed directly.

Next, effects of the water-stop structure 1A of the wire W are described.

As described above, the water-stop structure 1A of the wire W according to an aspect of the first embodiment includes the wire W including the covering portion 3 that covers the plurality of element wires 2 being twisted and the element wire exposing portion 4 in which the plurality of element wires 2 being twisted are partially exposed from the covering portion 3. Further, the water-stop structure 1A of the wire W includes the sealing member 7A that seals the element wire exposing portion 4 of the wire W under a state in which the plurality of element wires 2 in the element wire exposing portion 4 of the wire W are untwisted.

At the time of performing water-stop treatment with the sealing member 7A (the molded member 10), the thermoplastic resin material has viscosity that is too high to permeate into the gap between the element wires 2, and it may be difficult to seal the gap between the element wires 2. Thus, even when the thermoplastic resin material has relatively high viscosity, the gap between the element wires 2 can be sealed by mechanically providing a space between the element wires 2.

The gap between the element wires 2 is increased by untwisting the element wires 2 in the element wire exposing portion 4 of the wire W. The thermoplastic resin material enters the gap between the element wires 2 at the time of molding the secondary molded component 12 to fill the gap. With this, water-stop for the element wire exposing portion 4 of the wire W can be performed. With this, usage of an adhesive agent with high fluidity and permeation work in advance can be eliminated.

With this, the need for work to fill a gap between element wires with a water-stop agent, which is required in the related art, is not required, and labor and efforts required for manual work are reduced. Thus, entry of water into the element wire exposing portion 4 of the wire W can securely be prevented, quality can be improved, and labor saving and cost reduction can be achieved.

In the water-stop structure 1A of the wire W according to an aspect of the first embodiment, the sealing member 7A is the molded member 10 formed of a thermoplastic resin material. A part of the thermoplastic resin material forming the molded member 10 may enter the gap generated between the element wires 2, and the gap may be filled with the thermoplastic resin material.

Permeation of an adhesive agent with high fluidity in advance is not required because the thermoplastic resin material enters the gap between the element wires 2, and molding for water-stop treatment can be performed directly.

The manufacturing method of the water-stop structure 1A of the wire W according to an aspect of the first embodiment includes forming, in the wire W including the covering portion 3 that covers the plurality of element wires 2 being twisted, the element wire exposing portion 4 in which the plurality of element wires 2 being twisted are partially exposed from the covering portion 3. The manufacturing method includes forming the gap between the plurality of element wires 2 by rotating the element wire exposing portion 4 of the wire W in the direction D opposite to the twisting direction of the element wires 2 and untwisting the plurality of element wires 2 in the element wire exposing portion 4 of the wire W, and sealing the element wire exposing portion 4 of the wire W with the sealing member 7A.

At the time of performing water-stop treatment with the sealing member 7A (the molded member 10), the thermoplastic resin material has viscosity that is too high to permeate into the gap between the element wires 2, and it may be difficult to seal the gap between the element wires 2. Thus, even when the thermoplastic resin material has relatively high viscosity, the gap between the element wires 2 can be sealed by mechanically providing a space between the element wires 2.

The gap between the element wires 2 is increased by untwisting the element wires 2 in the element wire exposing portion 4 of the wire W. The thermoplastic resin material enters the gap between the element wires 2 at the time of molding the secondary molded component 12 to fill the gap. With this, water-stop for the element wire exposing portion 4 of the wire W can be performed. With this, usage of an adhesive agent with high fluidity and permeation work in advance can be eliminated.

The manufacturing method of In the water-stop structure 1A of the wire W according to an aspect of the first embodiment, the sealing member 7A is the molded member 10 formed of a thermoplastic resin material. The thermoplastic resin material may enter the gap generated between the element wires 2 at the time of molding the molded member 10, and the gap may be filled with the thermoplastic resin material.

Permeation of an adhesive agent with high fluidity in advance is not required because the thermoplastic resin material enters the gap between the element wires 2, and molding for water-stop treatment can be performed directly.

### Second Embodiment

Next, a water-stop structure 1B of a wire W according to a second embodiment is described. Note that the constituent elements that are substantially the same as those of the water-stop structure of the wire described above are denoted with the same reference symbols, and description therefor is omitted.

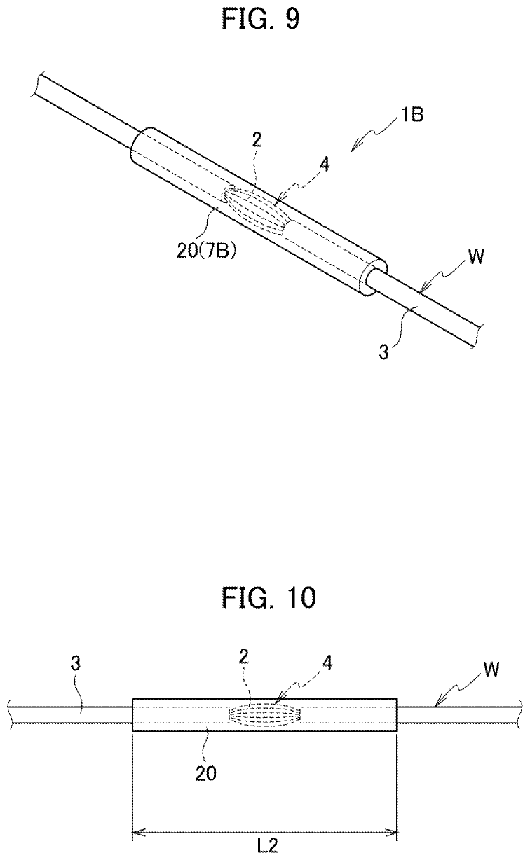

FIG. 9 is a perspective view illustrating the water-stop structure 1B of the wire W according to the second embodiment.

The water-stop structure 1B according to the second embodiment includes the wire W and a heat shrinkable tube 20 being a sealing member 7b.

The sealing member 7b seals the element wire exposing portion 4 of the wire W under a state in which the plurality of element wires 2 in the element wire exposing portion 4 of the wire W are untwisted.

In the water-stop structure 1B of the wire W according to the second embodiment, the sealing member 7b is the heat shrinkable tube 20 including an inner surface provided with a water-stop agent (adhesive agent) formed of a thermoplastic resin material.

At least a part corresponding to the element wire exposing portion 4 of the wire W is covered with the heat shrinkable tube 20. A length L2 of the heat shrinkable tube 20 (see FIG. 10) is approximately 40 mm, for example. The heat shrinkable tube 20 is formed of synthetic resin material such as polyolefin. The water-stop agent provided to the inner surface of the heat shrinkable tube 20 is formed of a hot-melt adhesive agent containing a thermoplastic polymer as a component, an instantaneous adhesive agent, or the like.

Although details are described later, the water-stop agent on the inner surface of the heat shrinkable tube 20 is softened at the time of heating the heat shrinkable tube 20, and the gap between the plurality of element wires 2 that is generated through untwisting is filled with the water-stop agent (thermoplastic resin material) being softened. After that, the thermoplastic resin layer (omitted in illustration) filling the gap between the plurality of element wires 2 is formed inside the heat shrinkable tube 20 by cooling and solidifying the water-stop agent.

The manufacturing method of the water-stop structure 1B of the wire W according to the second embodiment is described below.

FIG. 10 is an explanatory view illustrating an example of a step in the manufacturing method of the water-stop structure 1B of the wire W.

The steps [1] to [4] (see FIG. 4 to FIG. 7) are similar to those in the first embodiment, and hence description for those steps is omitted.

[5] Water-stop Treatment with Heat Shrinkable Tube 20

The heat shrinkable tube 20 is arranged on the wire W so as to cover at least the element wire exposing portion 4 of the wire W in which the element wires 2 are untwisted. Further, the water-stop agent on the inner surface of the heat shrinkable tube 20 is softened by heating the heat shrinkable tube 20, and the gap between the element wires 2 that is formed through untwisting is filled with the water-stop agent (thermoplastic resin material) being softened. After the heat shrinkable tube 20 is heated, the heat shrinkable tube 20 is cooled (including natural cooling). In other words, permeation of an adhesive into the element wires 2 in the element wire exposing portion 4 is not performed in advance, and the heat shrinkable tube 20 is heated. In this manner, water-stop treatment for the element wire exposing portion 4 of the wire W is completed.

An adhesive agent with high fluidity is not required to permeate into the element wire exposing portion 4 in advance because the thermoplastic resin material enters the gap between the element wires 2 in the element wire exposing portion 4, and water-stop treatment for the element wire exposing portion 4 of the wire W can be performed directly.

Next, effects of the water-stop structure 1B of the wire W are described.

As described above, the water-stop structure 1B of the wire W according to an aspect of the second embodiment includes the wire W including the covering portion 3 that covers the plurality of element wires 2 being twisted and the element wire exposing portion 4 in which the plurality of element wires 2 being twisted are partially exposed from the covering portion 3. Further, the water-stop structure 1B of the wire W includes the sealing member 7b that seals the element wire exposing portion 4 of the wire W under a state in which the plurality of element wires 2 in the element wire exposing portion 4 of the wire W are untwisted.

At the time of performing water-stop treatment with the sealing member 7b (the heat shrinkable tube 20), the thermoplastic resin material has viscosity that is too high to permeate into the gap between the element wires 2, and it may be difficult to seal the gap between the element wires 2. Thus, even when the thermoplastic resin material has relatively high viscosity, the gap between the element wires 2 can be sealed by mechanically opening a space between the element wires 2.

The gap between the element wires 2 is increased by untwisting the element wires 2 in the element wire exposing portion 4 of the wire W. The thermoplastic resin material (water-stop agent) enters the gap between the element wires 2 at the time of heating the heat shrinkable tube 20 to fill the gap. With this, water-stop for the element wire exposing portion 4 of the wire W can be performed. With this, usage of an adhesive agent with high fluidity and permeation work in advance can be eliminated.

With this, the need for work to fill a gap between element wires with a water-stop agent, which is required in the related art, is not required, and labor and efforts required for manual work are reduced. Thus, entry of water into the element wire exposing portion 4 of the wire W can securely be prevented, quality can be improved, and labor saving and cost reduction can be achieved.

In the water-stop structure 1B of the wire W according to an aspect of the second embodiment, the sealing member 7b is the heat shrinkable tube 20 including an inner surface provided with a water-stop agent formed of a thermoplastic resin material. A part of the thermoplastic resin material forming the water-stop agent may enter the gap generated between the element wires 2, and the gap may be filled with the thermoplastic resin material.

Permeation of an adhesive agent with high fluidity in advance is not required because the thermoplastic resin material enters the gap between the element wires 2, and water-stop treatment with the heat shrinkable tube 20 can be performed directly.

The manufacturing method of the water-stop structure 1B of the wire W according to an aspect of the second embodiment includes forming, in the wire W including the covering portion 3 that covers the plurality of element wires 2 being twisted, the element wire exposing portion 4 in which the plurality of element wires 2 being twisted are partially exposed from the covering portion 3. The manufacturing method includes forming the gap between the plurality of element wires 2 by rotating the element wire exposing portion 4 of the wire W in the direction D opposite to the twisting direction of the element wires 2 and untwisting the plurality of element wires 2 in the element wire exposing portion 4 of the wire W, and sealing the element wire exposing portion 4 of the wire W with the sealing member 7b.

At the time of performing water-stop treatment with the sealing member 7b (the heat shrinkable tube 20), the thermoplastic resin material has viscosity that is too high to permeate into the gap between the element wires 2, and it may be difficult to seal the gap between the element wires 2. Thus, even when the thermoplastic resin material has relatively high viscosity, the gap between the element wires 2 can be sealed by mechanically opening a space between the element wires 2.

The gap between the element wires 2 is increased by untwisting the element wires 2 in the element wire exposing portion 4 of the wire W. The thermoplastic resin material (water-stop agent) enters the gap between the element wires 2 at the time of heating the heat shrinkable tube 20 to fill the gap. With this, water-stop for the element wire exposing portion 4 of the wire W can be performed. With this, usage of an adhesive agent with high fluidity and permeation work in advance can be eliminated.

In the manufacturing method of the water-stop structure 1B of the wire W according to an aspect of the second embodiment, the sealing member 7b is the heat shrinkable tube 20 including an inner surface provided with a water-stop agent formed of a thermoplastic resin material. The thermoplastic resin material forming the water-stop agent may enter the gap generated between the element wires 2 by heating the heat shrinkable tube 20, and the gap may be filled with the thermoplastic resin material.

Permeation of an adhesive agent with high fluidity in advance is not required because the thermoplastic resin material enters the gap between the element wires 2, and water-stop treatment with the heat shrinkable tube 20 can be performed directly.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A water-stop structure of a wire, comprising:
a wire including:
a covering portion configured to cover a plurality of element wires being twisted; and
an element wire exposing portion in which the plurality of element wires being twisted are partially exposed from the covering portion; and
a sealing member configured to seal the element wire exposing portion of the wire under a state in which the plurality of element wires in the element wire exposing portion of the wire are untwisted.

2. The water-stop structure of a wire according to claim 1, wherein
the sealing member is a molded member formed of a thermoplastic resin material, and
a part of the thermoplastic resin material forming the molded member enters a gap that is generated between the plurality of element wires to fill the gap with the thermoplastic resin material.

3. The water-stop structure of a wire according to claim 1, wherein
the sealing member is a heat shrinkable tube having an inner surface provided with a water-stop agent formed of a thermoplastic resin material, and
a part of the thermoplastic resin material forming the water-stop agent enters a gap that is generated between the plurality of element wires to fill the gap with the thermoplastic resin material.

4. A manufacturing method of a water-stop structure of a wire, comprising:
forming, in a wire including a covering portion configured to cover a plurality of element wires being twisted, an element wire exposing portion in which the plurality of element wires being twisted are partially exposed from the covering portion;
forming a gap between the plurality of element wires by rotating the element wire exposing portion of the wire in a direction opposite to a twisting direction of the plurality of element wires and untwisting the plurality of element wires in the element wire exposing portion of the wire; and
sealing the element wire exposing portion of the wire with a sealing member.

5. The manufacturing method of a water-stop structure of a wire according to claim 4, wherein
the sealing member is a molded member formed of a thermoplastic resin material, and
at the time of molding the molded member, the thermoplastic resin material enters a gap that is generated between the plurality of element wires to fill the gap with the thermoplastic resin material.

6. The manufacturing method of a water-stop structure of a wire according to claim 4, wherein
the sealing member is a heat shrinkable tube having an inner surface provided with a water-stop agent formed of a thermoplastic resin material, and
at the time of heating the heat shrinkable tube, the thermoplastic resin material forming the water-stop agent enters a gap that is generated between the plurality of element wires to fill the gap with the thermoplastic resin material.
